(19) United States
(12) Patent Application Publication
(10) Pub. No.: US 2015/0101465 A1
(43) Pub. Date: Apr. 16, 2015

(54) CAM ASSEMBLY

(71) Applicant: Brian James Cutler, Rowland Heights, CA (US)

(72) Inventor: Brian James Cutler, Rowland Heights, CA (US)

(21) Appl. No.: 14/574,252

(22) Filed: Dec. 17, 2014

Related U.S. Application Data
(63) Continuation of application No. 13/476,818, filed on May 21, 2012.

(51) Int. Cl. B25B 23/142; F16D 7/02

(52) U.S. Cl. CPC B25B 23/1427; F16D 7/024
USPC 81/475; 29/469.5; 29/428; 192/107 M

(57) ABSTRACT

A torque-limiting driving tool having a body having an axis of rotation, an elongated shaft disposed along the axis of rotation and supported by the body, and a torque-limiting element disposed to limit the amount of torque imposed on the body which is transmitted to the elongated shaft. The torque-limiting element includes opposed cams each of which comprises a metallic cam surface and a non-metallic structural base which is disposed to hold the metallic cam surface in operable position within the body. The torque-limiting driver may have a torque-adjustment element which is operable to adjust the torque value to which the transmitted torque is limited, which may include a plug bearing threads which are compatible with threads of the body. The body may include a locking element which drivably interacts with the plug to resist spontaneous rotation of the plug.

### CROSS-REFERENCE TO RELATED APPLICATION

This application is a continuation and claims the benefit of the filing date of U.S. patent application Ser. No. 13/486,818, filed May 21, 2012, which claims the benefit of the filing date of U.S. Provisional Application Ser. No. 61/487,802, filed May 19, 2011, the contents of which are incorporated herein by reference.

### BACKGROUND

This application relates generally to a cam assembly that can be used in driving tools such as screwdrivers, nut drivers, bolt drivers, wrenches and the like wherein the amount of torque that the tool can apply to a given fastener is limited to a settable value. More specifically, this application relates to a cam assembly that utilizes a metal face portion that can be coupled to or molded to a resin or plastic blank.

Torque settable drivers as described above are well known in the art. This application relates to a cam assembly in used drivers that are designed for specific uses and thus a lockable torque value is desirable. The need for a lockable torque-limiting driver that can drive a given fastener at a desired torque value is useful in a variety of fields including sporting goods, electronics and computer assembly, and any other use wherein specific tolerances are required. However, it would be desirable if there was a cam assembly construction assures that the lower face and the upper face will have good wear characteristics, while being easily formed to the exact curvature or profile deemed most suitable for their cam characteristics. It would also be desirable for such a cam assembly would be low-cost and suitable for mass production without sacrificing precision.

### SUMMARY

This application discloses a cam assembly usable in a settable torque-limiting driver that is economical to produce, of simple construction and capable of mass production, but also capable of being locked in a variety of precise torque settings.

In particular, this application discloses a cam assembly usable in a torque-limiting driver which may in other aspects be similar to those which are the subject of the aforementioned related applications, but which is a variation on torque-limiting and -adjusting structure shown in the prior related applications.

Notably, the torque performance characteristics are provided by cam assemblies which are inexpensive to fabricate, yet are wear resistant and effective in operation.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a torque-limiting driver, shown assembled.

FIG. 2 is an exploded view of the driver of FIG. 1.

FIG. 3 is an enlarged perspective detail view of cam elements forming a part of components seen at the upper left of FIG. 2.

### DETAILED DESCRIPTION

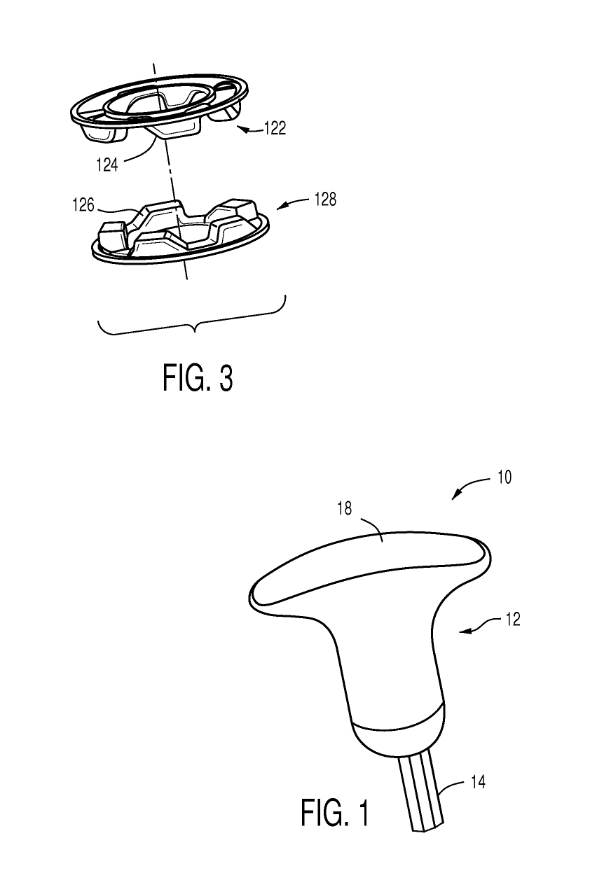

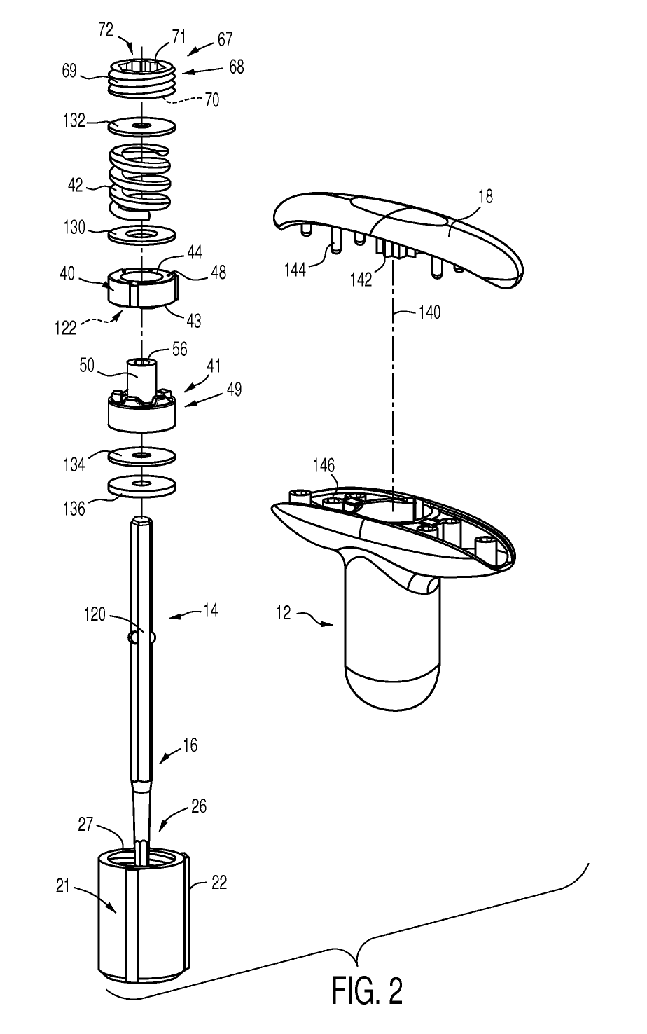

Referring to FIGS. 1 and 2, shown therein and generally designated by the reference character 10 is a lockable toque-limiting driver constructed in accordance with the following description. The driver 10 may comprise a body 12 having an elongated shaft 14 with a fastener-engaging portion 16 extending from one end thereof. At the other end, the driver 10 may be provided with a cap member 18.

The driver 10 may comprise a sleeve 21 having an elongated, hollow, generally cylindrical body 22 with an axial bore 26 formed therethrough. The inner surface of sleeve 21 may include threads 27 at its upper and open end.

It should be noted at this point that orientational terms such as upper and lower refer to the subject drawing as viewed by an observer. The drawing figures depict their subject matter in a representative orientation of use, which could obviously change with changes in the way a user holds the driver 10. Therefore, orientational terms must be understood to provide semantic basis for purposes of description, and do not limit the invention or its component parts in any particular way.

The elongated shaft 14 above the fastener-engaging portion 16 may be hexagonal shaped in transverse cross section to provide a keying effect. The driver 10 may include a torque-limiting element which is operable to adjust the torque value to which the transmitted torque is limited, which may comprise an upper non-rotational cam assembly 40, a lower rotational cam assembly 41, and a compression spring 42. More particularly, upper cam assembly 40 may include an annular body 43 and a cylindrical bore 44 formed axially therethrough. On the outer surface of annular body 43 a channel 120 may extend longitudinally. The upper cam assembly 40 has may have an upper face 48 and a lower face 122. More easily seen in the enlarged detail of FIG. 3, the lower face 122 may comprise circumferentially spaced ramps such as a ramp 124. The lower face 122 may comprise a plurality of ramps such as the ramp 124, which will interact with corresponding ramps 126 which are formed in an upper face 128 of the lower cam assembly 41. In operation, the lower face 122 rides across the surface of the corresponding ramps 126 of the upper face 128. The upper face 48 and the lower face 122 will tend to resist riding over one another due to mutually compressing forces imposed by the compression spring 42. As will be further explained hereinafter, this will cause rotation of the driver 10 by a person using it to rotate the shaft 14, and thus drive any object (not shown) intended to be rotated by the driver 10. Rotation for driving purposes will be understood to be rotation about a central axis 140 of the driver 10.

However, when resistance of the object being rotated exceeds the resistance established by interaction of the ramps 124 and 126, the upper and lower cam assemblies 40 and 41 will ride over one another, thus breaking the rotatable driving relation between the body 12 and the shaft 14. This effectively limits the maximal torque which can be transmitted to the object being rotated.

The lower cam assembly 41 may include an elongated cylindrical portion 49 at one end and an elongated location boss portion 50 at the other.

The compression spring 42 may seat on a washer 130 which abuts the upper face 48 of the upper cam 40. A corresponding washer 132 may form a seat above the compression spring 42.

Washers 134, 136 may be provided below the cylindrical portion 49.

The driver 10 may comprise a torque-adjustment element, which in turn may comprise a threaded member, wherein the body 12 of the torque-limiting driver 10 comprises threads which are matingly compatible with the threads of the threaded member. The threaded member may comprise an annular adjustment plug 67. The adjustment plug 67 may have an annular body 68 with an externally threaded surface 69, a lower end face 70, an upper end face 71, and a bore defining a keyway structure 72 therethrough. As seen in FIG. 2, the keyway structure 72 may comprise a polygonal bore such as a hexagon. The extent to which the adjustment plug 67 is threaded into the sleeve 21 controls the amount of compression on the compression spring 42, which, in turn, controls the force with which the upper cam assembly 40 is driven into engagement with the lower cam assembly 41. Thus, the limiting torque required to effect the relative rotation of the upper and lower cam assemblies 40, 41 can be set to a desired torque value.

To effect the threading of the adjustment plug 67 to the desired position, a wrench (not shown) or the like can be used to engage the keyway structure 72.

The driver 10 may comprise a locking element which drivably interacts with the adjustment plug 67 to resist rotation of the latter, whereby adjustment of the torque-adjustment element is constrained against going out of adjustment spontaneously. To maintain the desired torque value, the driver 10 includes a torque-locking means, which comprises a locking boss 142 formed as part of the cap 18 which forms part of the body 12. The cap 18 may fit to the body 12 by interfit of pegs 144 and hollow bosses 146 for example to effect final assembly.

The locking boss 142 may have an outer surface which drivably interacts with the keyway structure 72. Illustratively, the outer surface may be hexagonal. After the torque is adjusted to the desired value, the cap member 18 may be fitted to the body 12. Engagement of the body 12 by the cap member 18, which may be a snap or frictional fit for example, will assure that the adjustment plug 67 will not move inadvertently, or alternatively stated, rotate out of its adjusted position.

The body 12 and the cap member 18 may collectively provide a grippable surface 95, which may bear a cushion (not shown) if desired, and/or a label or other graphical device for displaying a name, logo, or other indicia (none shown).

An important feature of the invention lies in construction of the upper and lower cam or weight or other force bearing surface assemblies 40, 41. The lower face 122 and the upper face 128 may each be fabricated from sheet metal for example. The remaining component of the respective upper and lower cam assemblies 40, 41 may be molded from a synthetic resin or plastic for example. For the upper cam assembly 40, the remaining component would be the annular body 43. For the lower cam assembly 41, the remaining component would be the elongated cylindrical portion 49 and the elongated location boss portion 50, which are preferably formed as a single molded component. The lower face 122 and the upper face 128, which may be pre-fabricated, may then each be placed in a mold and joined to their respective remaining components in a molding operation, so that the respective upper and lower cam assemblies 40, 41 will each be a single solid component. Alternatively, the prefabricated upper and lower cam faces 122, 128 may be attached is some permanent manner (glue, weld, interlock, etc) to a prefabricated “blank” made from a suitable resin or plastic.

This construction assures that the lower face 122 and the upper face 128 will have good wear characteristics, while being easily formed to the exact curvature or profile deemed most suitable for their cam characteristics. At the same time, the upper and lower cam assemblies 40, 41 need not be formed entirely from metal, which would be an expensive proposition.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A torque-limiting driver, comprising:
a body having an axis of rotation;
an elongated shaft disposed along the axis of rotation and supported by the body, wherein the elongated shaft is shaped in transverse cross section to provide a keying effect for drivably engaging an object to be driven; and
a torque-limiting element disposed to limit the amount of torque imposed on the body which is transmitted to the elongated shaft, comprising opposed cams each of which comprises a metallic cam surface and a non-metallic structural base which is disposed to hold the metallic cam surface in operable position within the body of the torque-limiting driver.

2. The torque-limiting driver of claim 1, further comprising a torque-adjustment element which is operable to adjust the torque value to which the transmitted torque is limited.

3. The torque-limiting driver of claim 2, wherein the torque-adjustment element comprises a plug bearing threads, and wherein the body of the torque-limiting driver comprises threads which are matingly compatible with the threads of the plug.

4. The torque-limiting driver of claim 3, wherein the body comprises a locking element which drivably interacts with the plug to resist rotation of the plug, whereby adjustment of the torque-adjustment element is constrained against going out of adjustment spontaneously.

5. A metallic and non-metallic device comprising:
a metallic weight or force bearing surface; and
a non-metallic structural base material wherein said metallic weight or force bearing surface is fixably attached to said non-metallic structural base material to at least one surface.

6. A metallic and non-metallic device of claim 5, wherein said device is a cam assembly comprising a metallic cam surface and a non-metallic structural base.

7. The metallic and non-metallic device of claim 5, wherein the non-metallic base is made from a moldable material selected from the group consisting of plastic and resin.

8. The metallic and non-metallic device of claim 5, wherein the metallic weight or force bearing surface and non-metallic structural base is fixably attached by one from the group consisting of glue, weld, and interlock.

9. The metallic and non-metallic device of claim 5, made by the process of bonding the non-metallic structural base to the metallic cam surface.

10. A method of generating a metallic weight or force bearing surface on a non-metallic structural base comprising the steps of:
stamping out said metallic weight or force bearing surface on a sheet of metal; and
fixing said metallic weight or force bearing surface to said non-metallic structural base.

11. A method of claim 10, wherein a step of fixing said metallic weight or force bearing surface into a mold wherein said non-metallic structural base is injected to make a single solid component.

12. The method of claim 10, wherein the non-metallic base is made from a moldable material selected from the group consisting of plastic and resin.

13. The method of claim 10, wherein the metallic weight or force bearing surface is fixably attached to a non-metallic structural base.

14. The method of claim 10, wherein the metallic weight or force bearing surface and non-metallic structural base are fixably attached by one from the group consisting of glue, weld, and interlock.
